(19) United States
(12) Patent Application Publication
(10) Pub. No.: US 2018/0014663 A1
(43) Pub. Date: Jan. 18, 2018

(54) MAGNETIC DISPLAY APPARATUS

(71) Applicants: Hemal Ratanjee, Orange, CA (US); Sumati Dhansukhlal Ratanjee, Orange, CA (US)

(72) Inventors: Hemal Ratanjee, Orange, CA (US); Sumati Dhansukhlal Ratanjee, Orange, CA (US)

(21) Appl. No.: 15/212,257

(22) Filed: Jul. 17, 2016

(51) Int. Cl. A47G 1/06; G09F 7/04

(52) U.S. Cl. CPC A47G 1/06; G09F 7/04; A47G 1/0633; A47G 2001/0672

(57) ABSTRACT

A display apparatus has a rigid base providing a planar face, and a planar sheet magnet bonded to the planar face. A first canvas sheet abuts the sheet magnet and further is wrapped about the magnet sheet as well as the rigid base. A second canvas sheet abuts the first canvas sheet. The second canvas sheet is coated with an iron bearing material. The rigid base, sheet magnet, and canvas sheets are in mutual face-to-face contact and have an essentially common outer peripheral edge. The canvas sheets are magnetically engaged with the sheet magnet with the second canvas sheet manually disengageable from the first canvas sheet so as to be able to replace it with a alternate second canvas sheet. The second canvas sheets may have art works or graphics depicted on their out-facing surfaces.

### FIELD OF THE DISCLOSURE

The invention relates generally to display systems. More particularly, the invention relates to artwork display systems with elements that are magnetically engaged to promote and facilitate modifications to artwork on display.

### BACKGROUND

Flat art, also known as fine art, pop art, pictorials, photographs, paintings, lithographs and graphics to name just a few, is well known and has been used to present artistic expression since at least Paleolithic times represented, for instance, by cave paintings which were found at Lascaux in southwestern France on cave walls depicting the hunting of animals. Commonly, we find murals and graffiti on the exterior walls of buildings and framed art or posters hung on interior walls. Typically, art pieces are mounted on or within frames. However, often it is desirable to change the pictorial element of a framed artwork without the difficulty and cost of replacing the frame and the hanging mechanisms. One solution is found in a common item in contemporaneous use is the electronic picture frame that presents pictorial representations on an electronic screen in sequence where the user has control of screen brightness, coloration, and presentation rate, and of course, subject matter. This type of device is often used to display family photos, and also, in a much larger size, for commercial presentations in public spaces.

Flat art is widely hung on the walls of homes and offices. The inconvenience and expense of replacing these items when they no longer delight, are damaged, faded, out of style, or out of vogue is a problem. Therefore, there is a need for a means of overcoming this inconvenience and cost while still providing a means for replacing old artistic representations with new.

### SUMMARY

In view of the foregoing, the presently described and illustrated invention fulfills this need. In this approach, a display apparatus uses a frame of the type used for stretching art canvas. Such a frame may be almost any size and shape but rectangular is preferred. Attached to a face of the wooden frame is a thin rigid plate and attached to the face of the plate is a sheet magnetic. A canvas is placed over the sheet magnetic and stretched around the sides, top and bottom of the sheet magnet and frame and then secured to it. The canvas sheet may be coated with an iron bearing substance so that it is magnetically attracted to and secured against the sheet magnet. A second canvas sheet having the same iron bearing coating may be placed over the first canvas sheet and will be attracted to the sheet magnetic also so that it is secured in place. The second canvas sheet may have the same outside dimensions as the frame and may have an artistic representation on its out-facing surface. The second canvas sheet may be peeled away and replaced by another thereby presenting a new art image. Clearly, this overcomes the difficulties of the prior art as described in the background above.

These and other aspects of embodiments herein described will be better appreciated when considered in conjunction with the following detailed description and the accompanying drawings. It should be understood, however, that the following described embodiments, while indicating preferred approaches, are given by way of illustration and not of limitation. Many changes and modifications may be made within the scope of the embodiments without departing from the spirit thereof, and the invention should be considered to include all such modifications.

In this document, the terms “a” or “an” are used, as is common in patent documents, to include one or more than one. Furthermore, the term “or” is used to refer to a nonexclusive “or,” such that “A or B” includes “A but not B,” “B but not A,” and “A and B,” unless otherwise indicated.

### BRIEF DESCRIPTION OF THE DRAWINGS

Embodiments of the described apparatus are illustrated only as examples in the figures of the accompanying drawing sheets wherein the same reference numeral refers to the same element as it may appear in multiple drawing sheets.

FIG. 1 is an expanded perspective view of an apparatus as viewed frontally as disclosed herein;

FIG. 2 is a rear perspective view of portions thereof as assembled; and

FIG. 3 is a front perspective view of the portions of FIG. 2.

### DETAILED DESCRIPTION

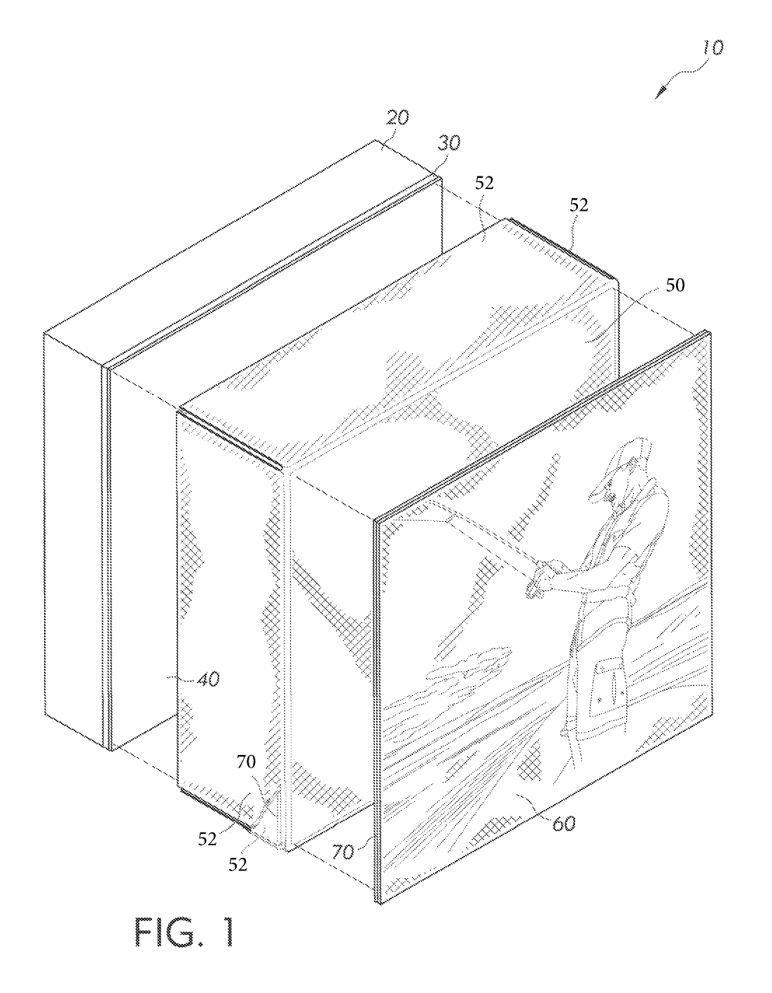

Described now and shown in the accompanying drawing sheets is a display apparatus 10 for displaying works of art and graphics as a planar study, i.e., flat art. Apparatus 10 may have several mutually abutting elements comprising a completed assembly that may be handled, moved and placed as a single object. Each one of said elements is in planar face-to-face contact with its preceding and subsequent neighbor element, if any. This arrangement is indicated in FIG. 1.

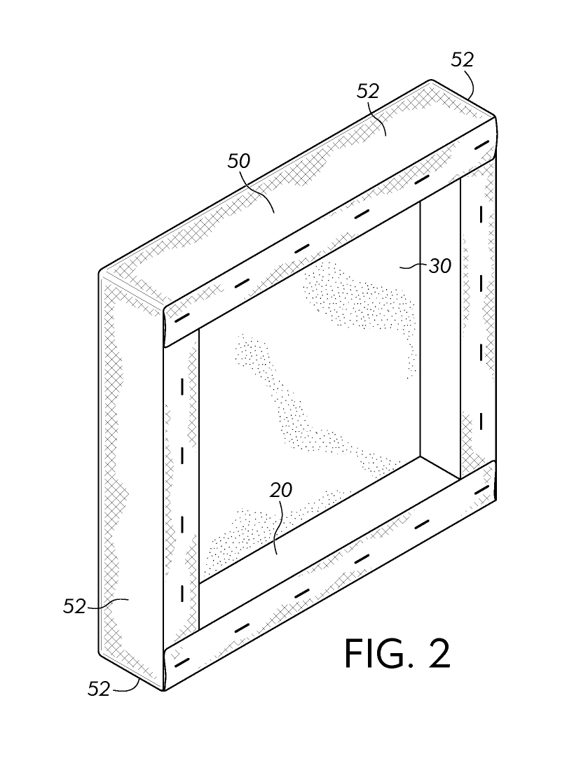

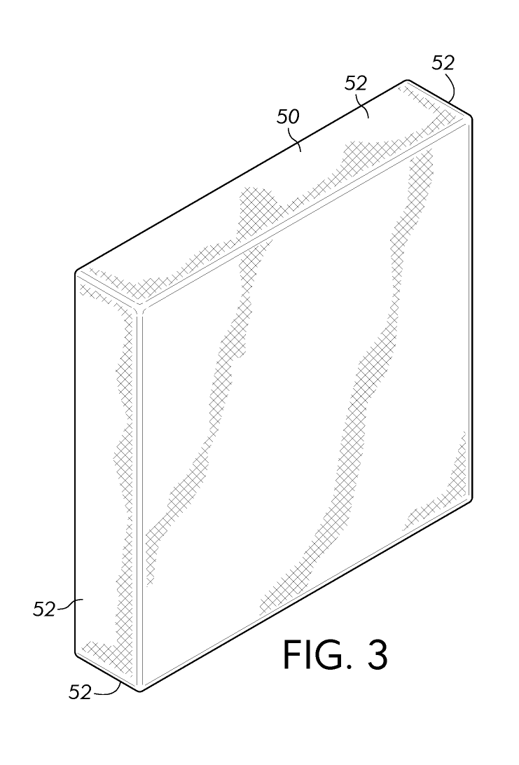

The elements may include a rigid base 20, a plate 30, a sheet permanent magnet 40, a first fabric sheet 50 and a second fabric sheet 60. Elements 50 and 60 may each lie adjacent to, or be integral with a ferromagnetic layer 70 as shown. As shown in FIGS. 2 and 3, folded over portions 52 of fabric sheet 50 extend peripherally into contact with rigid base 20, are wrapped around it, and are secured thereto by staples or other common attachment means. Fabric sheet 50 is pulled toward base 20 so as to apply a compressive force against sheet magnet 40 so that it is unable to move relative to base 20 during normal handling.

In an embodiment where layer 70 is integral with fabric sheet 50, both are pressed against sheet magnet 40 by magnetic attraction between sheet magnet 40 and iron bearing ferromagnetic layer 70. Second fabric sheet 60 may be pressed against first fabric sheet 50 also by magnetic attraction between sheet magnet 40 and iron bearing ferromagnetic layer 70 integral with fabric sheet 60.

Referring now to FIG. 2, rigid base 20 may be fabricated of wood, metal, or other rigid structural material and may have a frame portion integral with plate 30 as a single part. Alternately, plate 30 may be a separate part as shown in FIG. 1. In this case plate 30 may be joined the frame portion by any common mechanical or chemical fastening method. Either way, plate portion 30 presents a continuous, rigid, planar surface against which sheet magnet 40 may rest face to face. The peripheral edges of plate 30 and sheet magnet 40 may be contiguous.

Sheet magnet 40 may be an injection molded magnet made of a resin mixed with magnetic powder or it may be a high-coercivity ferromagnetic compound such as ferric oxide mixed with a plastic binder. It may be a multi-pole magnet of up to 0.060 inches in thickness providing an energy product in the range of about 0.78 megagauss oersteds which has been found to be necessary for meeting the objective of mounting element 60 with stability. A plastic layer (not shown) may be laminated to sheet magnet 40 functioning to secure magnet 40 from cracking, separating, ejecting particles, and similar objectives. Such a plastic layer may be of polypropylene and may be laminated to sheet magnet 40 on one side or both sides thereof.

Fabric sheets 50 and 60 may be art grade canvas sheeting of between approximately 0.020 and 0.026 inches in thickness. This thickness range has been found to provide excellent mechanical characteristics for the preferred application; including strength, foldability, and surface texture. Canvas sheeting outside this range is problematic in that thinner layers fail to provide adequate strength in the intended application and thicker layers fail to provide adequate foldability generating unsightly bulging at folds, and also have a course texture unsuitable for the artistic purpose sought which is usually rendered by a printing process.

Said iron bearing layers 70 may be made up of a silicon rubber carrier filled with immersed nanoscale iron particles. Such sub-micrometer particles are widely used in medical and laboratory applications and have excellent magnetic properties. The iron particles are mixed into liquid silicone components and then sprayed or rolled onto one side of second fabric sheets 50 and 60. Once cured as a thin layer of approximately 0.002 to 0.006 inches thickness it becomes nested within the fibers of the canvas fabric. Layer 70 in this thickness range produces a negligible amount of stiffening of the fabric sheets 50 or 60, but provides the advantage of being strongly drawn to sheet magnet 40 with a maximum dielectric gaps of 0.026 inches. Fabric sheet 60 is easily placed over fabric sheet 50 for display, is strongly held in place by magnetic attraction, and yet is easily peeled away to be replaced by an alternate sheet 60 as desired.

In the foregoing description, embodiments are described as a plurality of individual parts, and methods as a plurality of individual steps and this is solely for the sake of illustration. Accordingly, it is contemplated that some additional parts or steps may be added, some parts or steps may be changed or omitted, and the order of the parts or steps may be re-arranged, while maintaining the sense and understanding of the apparatus and methods as claimed.

1-3. (canceled)

4-11. (canceled)

12. A magnetic display apparatus comprising:
a rigid base having a planar surface;
a sheet magnet of 0.060 inches maximum thickness rested against said planar surface of said rigid base, wherein peripheral edges of said rigid base and said sheet magnet are contiguously aligned;
a first fabric sheet of between 0.020 and 0.026-inches thickness positioned in contact with said sheet magnet, wherein said sheet magnet is compressed between said first fabric sheet and said rigid base, thereby maintaining said contiguous alignment;
a second fabric sheet, positioned adjacent to said first fabric sheet with a maximum gap between said fabric sheets of 0.026-inches;
iron nanoparticles integral within fibers of said fabric sheets wherein said fabric sheets are mutually engaged by magnetic attraction and wherein plural said second fabric sheets are interchangeable in adjacency with said first fabric sheet.

13. The magnetic display apparatus of claim 1 further comprising a plastic sheet layer laminated to said sheet magnet wherein said sheet magnet is sandwiched between said plastic sheet layer and said rigid base.

14. The magnetic display apparatus of claim 1 wherein said iron nanoparticles are immersed within a flexible polymer.
